(19) United States
(12) Patent Application Publication
(10) Pub. No.: US 2017/0116870 A1
(43) Pub. Date: Apr. 27, 2017

(54) AUTOMATIC TEST PERSONALIZATION

(71) Applicant: Duolingo, Inc., Pittsburgh, PA (US)

(72) Inventors: Connor Brem, Pittsburgh, PA (US); Jeffrey Brenzel, Pittsburgh, PA (US); Natalia Castillejo, Pittsburgh, PA (US); Burr Settles, Pittsburgh, PA (US); Awaneesh Verma, Pittsburgh, PA (US)

(21) Appl. No.: 14/919,380

(22) Filed: Oct. 21, 2015

(51) Int. Cl. G09B 5/04; H04L 29/06; H04L 29/08

(52) U.S. Cl. CPC G09B 5/04; H04L 67/306; H04L 65/4007

(57) ABSTRACT

System and methods for improving automated test personalization are disclosed. The server system communicates a plurality of assessment questions to a client system for presentation to a user through a user interface. The system receives a user response for each transmitted assessment question and then compares the received user responses to reference data stored in an answer database at the server system to generate an estimated proficiency score for the user. Based on the generated estimated proficiency score, the server system automatically selects an interview prompt from a plurality of possible interview prompts. The server then communicates, to the client system, the selected interview prompt and instructions to cause the client system to record a live video of the user responding to the selected interview prompt. The server system then receives and stores a recorded live video of the user responding to the selected interview prompt.

### TECHNICAL FIELD

Embodiments of the present disclosure relate generally to evaluation applications and, more particularly, but not by way of limitation, to automatically personalize content for users.

### BACKGROUND

The rise in electronic and digital device technology has rapidly changed the way society interacts with media and consumes goods and services. Digital technology enables a variety of consumer devices to be available that are very flexible and relatively cheap. Specifically, modern electronic devices, such as smartphones and tablets, allow a user to have access to a variety of useful applications even when away from a traditional computer.

One particular use of computer technology is its use in providing user evaluation applications. Such applications can automate the process of testing or evaluating users on a variety of different fields of knowledge. These applications can be provided through a computer network, allowing more flexibility and freedom for users without sacrificing security and reliability.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIGS. 4A-4D are user interface diagrams illustrating examples of a user interface or web page having a personalized data feed (or content stream) via which a member of a social network service receives messages, status updates, notifications, and recommendations, according to some embodiments.

FIG. 5 depicts a block diagram of an exemplary data structure for user profile data, in accordance with some embodiments.

FIG. 6 is a flow diagram demonstrating a method, in accordance with some example embodiments, for automated test personalization.

FIGS. 7A-7C are a flow diagram illustrating a method, in accordance with some example embodiments, for automated test personalization.

FIG. 8 is a block diagram illustrating an architecture of software, which may be installed on any one or more of devices, in accordance with some example embodiments.

FIG. 9 is a block diagram illustrating components of a machine, according to some example embodiments.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments. It will be evident, however, to those skilled in the art, that embodiments of the inventive subject matter may be practiced without these specific details. In general, well-known instruction instances, protocols, structures, and techniques are not necessarily shown in detail.

Evaluation applications (e.g., testing applications) use a variety of tools to evaluate a user's skill or knowledge of a particular topic. For example, the MCAT examination is intended to evaluate a student's knowledge of and preparedness for the topics and skills to be learned in medical school. Thus, evaluation applications use questions, prompts, exercises, puzzles, and other tools to determine a user's skill level in a certain area of knowledge.

A client system, associated with a particular user, sends a request to the server system associated with the evaluation application. This request is generally generated by a user associated with the client system (e.g., the person using the system) selecting a link or option to begin an evaluation (e.g., a test that the user chooses to take). In some example embodiments, the server system uses stored information about the user associated with the client system to select a first evaluation question or prompt. In some example embodiments, the stored information was submitted by the user prior to initiating the evaluation application. For example, the stored information includes the user's education, previous test scores, demographic information, self-evaluated proficiency (e.g., the user can select a particular skill level), and so on.

In some example embodiments, the server system selects a question (or other prompt) based on the type of evaluation requested and any information stored about the user. In some example embodiments, the server system has a fixed first question for each type of evaluation (e.g., the server system always begins with Question A when evaluating Java programmers).

In other example embodiments, the server system selects a first question by determining the amount of information about the user's proficiency that will be gained from each question and selecting the question that will give the system the most information about the user's proficiency level. In some example embodiments, the server system uses statistical analysis of past evaluations and information about the user to determine which questions are the most useful in estimating a user's proficiency. In some example embodiments, questions are selected based on a time-efficiency metric such that the overall test time fits within a particular predetermined test length.

Once the first evaluation question or prompt is selected, the server system transmits it to the client system. The server system receives a response to the transmitted question or prompt from the client system. Each user response is entered by the user by interacting with a user interface displayed at the client system that is configured to receive user input. In response to receiving the user response, the server system selects another question to transmit to the client system.

The server system then continues to receive answers from a user and transmit new questions until the evaluation is complete. In some example embodiments, the evaluation application has a fixed number of questions that it sends to each user. In other example embodiments, the evaluation application continues to transmit questions to the user until the server system has achieved a predetermined level of certainty about the user's proficiency.

In accordance with a determination that the server system has completed the question-based evaluation, the server system determines an estimated level of proficiency for the user in the given skill area based on the user's answers to the plurality of questions. Using the determined level of proficiency, the server system selects one or more open-ended interview style prompts from a list of possible open-ended interview style prompts. Thus the evaluation is adaptive in that it changes based on an estimate proficiency level of the user. In this way, the evaluation is able to give a more accurate evaluation of a user's proficiency with a specific skill. In some example embodiments, an open-ended interview style prompt is a question or prompt that is not answered with a single word response or selection of one option from a list of possible options. Instead, an open-ended interview style questions is intended to demonstrate a skill in real time using a complicated prompt.

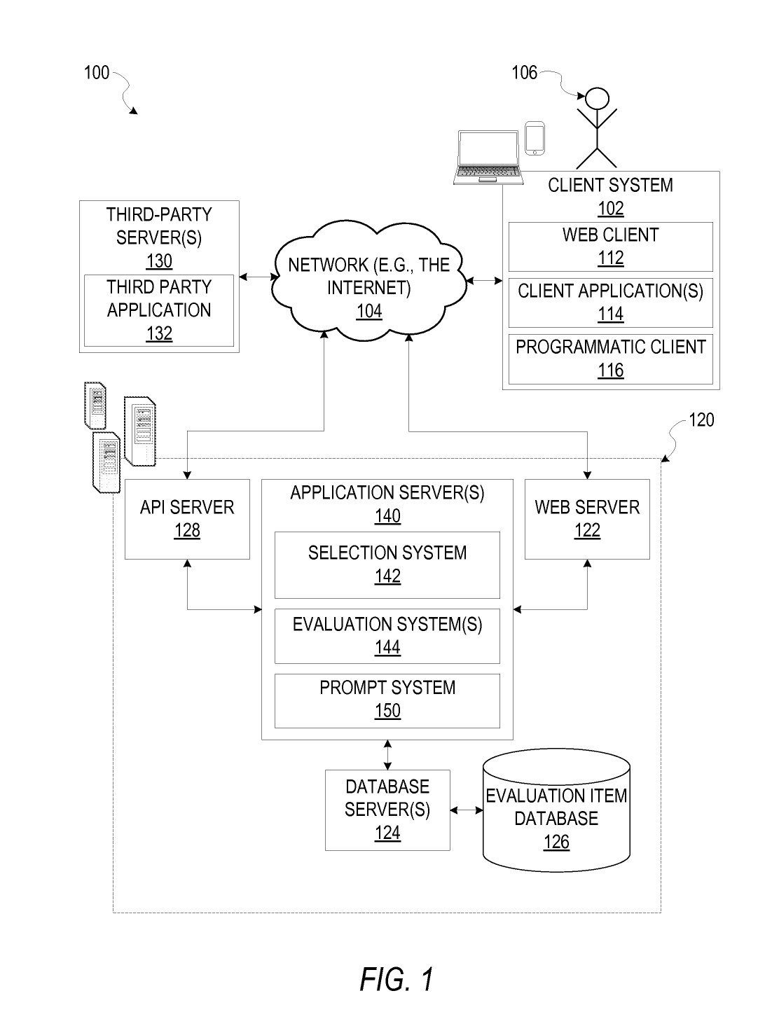

In some example embodiments, the server system selects questions or prompts that cover a wide variety of topics to ensure that the estimated proficiency score is not artificially inflated or deflated because only a narrow range of topics are selected. For example, if all the questions concern a single topic about which the user is very knowledgeable the estimated proficiency score may be too high. Similarly, evaluation prompts may be diversified based on prompt type or media type (e.g., spoken, written, image based, and so on). In some example embodiments, each potential prompt includes an associated topic. The server system (e.g., the server system 120 in FIG. 1) can use the associated topics to ensure topic diversity in the questions.

For example, for an evaluation of a user's language proficiency an open-ended interview style prompt would be an open ended question such as “What is your favorite animal and why?” For a programming position the open-ended interview style prompt might include a programming challenge or a debugging exercise. For a surgeon, the open-ended interview style prompt might include a simulated surgery.

The plurality of interview-style prompts have a variety of different questions for different proficiency levels. For example, an intermediate English speaker may be asked “Describe an item of clothing you like”, whereas an expert speaker may be asked “Should high school students be required to perform a year of community service? Why? Explain your position.”

The server system transmits the one or more selected open-ended interview style prompts to the user and instructs the client system to record the user's responses using a video recording device associated with the client system. In other example embodiments, the server system requests that only audio need be recorded for a particular interview question. In yet other example embodiments, the server system records the user performing a task such that only the screen activity and the inputs are recorded (e.g., a programming task).

In some example embodiments, the server system records a combination of the screen recording and the video. For example, a user interface (UI) design interview may involve designing something on a computer (screen recording) while also recording the user talking through their thought process (video or audio recording).

In some example embodiments, each open-ended interview system question includes a specific time limit that the user has in which to respond to the open-ended interview prompt. For example, for language evaluation, a user might have 50 seconds to respond to a prompt.

In some example embodiments, each interview prompt also includes a minimum response time. Thus, if the minimum response time is 20 seconds and the user responds to the interview prompt with a 10 second response, the server system can cause a dedicated application at the client system (e.g., the application that is presenting the evaluation to the user) to further prompt the user. For example, if the prompt is “tell me about your favorite animal” and the user ends prior to the end of the minimum time limit, the user can be further prompted with the prompt “Go on, tell me more.”

The recorded video of the user response to the open-ended interview style question is received by the server system and is stored at the server system as part of a user's profile. The user profile then includes user proficiency data (e.g., based on the user's response to various questions) and a recorded response to an open-ended interview style question that can be viewed by interested parties (e.g., when the user has given permission for a third party to view selected user information).

Thus, when a third party requests to see user information about a user's proficiency for a particular skill (or the user wishes that information to be sent to a particular person or organization), the server system transmits the proficiency data as well as the recorded user response to the requesting third party system.

In some example embodiments, the transmitted proficiency data includes both quantitative proficiency information and qualitative proficiency information. For example, quantitative proficiency information is a score that represents the user's performance on the evaluation questions provided by the server system. For example, the server system generates a score out of ten based on the determined level of proficiency for the user.

In some example embodiments, qualitative proficiency information includes one or more recorded live videos of the user demonstrating proficiency with the skill in question. Thus, when a third party (e.g., a potential employer or school) is evaluating users, they can use both qualitative and quantitative proficiency information to select candidates. For example, the third party can filter users based on their proficiency score (e.g., all users who score at least a 7 out of 10) and then use the recorded video data to select users from among the group of users that met the proficiency score requirements.

With reference to FIG. 1, an example embodiment of a high-level client-server-based network architecture 100 is shown. A server system 120, in the example form of a network-based application server system, provides server-side functionality via a network 104 (e.g., the Internet or wide area network (WAN)) to one or more client system 102. FIG. 1 illustrates, for example, a web client 112 (e.g., a browser, such as the Internet Explorer® browser developed by Microsoft® Corporation of Redmond, Wash. State), client application(s) 114, and a programmatic client 116 executing on the client system 102.

The client system 102 may comprise, but is not limited to, a mobile phone, laptop, portable digital assistant (PDA), smartphone, tablet, ultra book, netbook, laptop, multi-processor system, microprocessor-based or programmable consumer electronics system, game console, set-top box, or any other communication device that a user, such as a user 106, may utilize to access the server system 120. In some embodiments, the client system 102 may comprise a display module (not shown) to display information (e.g., in the form of user interfaces). In further embodiments, the client system 102 may comprise one or more of a touch screen, accelerometer, gyroscope, camera, microphone, global positioning system (GPS) device, and so forth.

The client system 102 may be a device of the user 106 that is used to perform a transaction involving digital items within the server system 120. In one embodiment, the server system 120 is a network-based application server that responds to requests for evaluation exercises or questions by transmitting one or more questions or prompts to the client system 102 and receives user responses to those prompts. One or more users 106 may be a person, a machine, or other means of interacting with the client system 102. In embodiments, the user 106 is not part of the network architecture 100, but may interact with the network architecture 100 via the client system 102 or another means. For example, one or more portions of the network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client system 102 may include one or more applications (also referred to as “apps”) such as, but not limited to, a web browser, messaging application, electronic mail (email) application, one or more applications dedicated to particular services (e.g., an evaluation application, a game application, a learning application, and so on), and the like. In some embodiments, if an application dedicated to a web-based interactive service is included in a given client system 102, then this application is configured to locally provide the user interface and at least some of the functionalities of the interactive service, with the application configured to communicate with the server system 120, on an as needed basis, for data and/or processing capabilities not locally available (e.g., new content, to access a database of items available for sale, to authenticate a user, to verify a method of payment, etc.). Conversely, if the web-based interactive service application is not included in the client system 102, the client system 102 may use its web browser to access the web-based interactive service hosted on the server system 120.

The one or more users 106 may be a person, a machine, or other means of interacting with the client system 102. For instance, the user 106 provides input (e.g., touch screen input or alphanumeric input) to the client system 102 and the input is communicated to the server system 120 via the network 104. In this instance, the server system 120, in response to receiving the input from the user 106, communicates information to the client system 102 via the network 104 to be presented to the user 106. In this way, the user 106 can interact with the server system 120 using the client system 102.

An application program interface (API) server 128 and a web server 122 are coupled to, and provide programmatic and web interfaces respectively to, one or more application servers 140. The application server(s) 140 may host a selection system 142, an evaluation system 144, and a prompt system 150, each of which may comprise one or more modules or applications and each of which may be embodied as hardware, software, firmware, or any combination thereof. The application server(s) 140 are, in turn, shown to be coupled to one or more database servers 124 that facilitate access to one or more evaluation item storage repositories or evaluation item database(s) 126. In an example embodiment, the evaluation item database(s) 126 are storage devices that store information to be used by the selection system 142 and prompt system 150. The evaluation item database(s) 126 may also store digital item information in accordance with example embodiments.

Additionally, a third-party application 132, executing on third-party server(s) 130, is shown as having access to the server system 120 via the interface provided by the API server 128 and the web server 122. For example, the third-party application 132 is able to connect to the server system 120 to receive evaluation items from and send responses to the server system 120.

The selection system 142 responds to requests from one or more client system 102 for evaluation questions or prompts or requests to begin a particular evaluation by determining one or more questions (or prompts) appropriate to send to the user. In some example embodiments, the selection system 142 uses information about the type of evaluation requested and any stored information about the requesting user.

In some example embodiments, the selection system 142 gathers information about the questions that are the most effective at determining a user's proficiency (e.g., based on statistical analysis of user responses compared against the user's ultimately determined skill level) and uses the gathered data to select one or more questions for the evaluation.

The evaluation system(s) 144 monitors the questions sent to a user and the responses the user returns. The evaluation system 144 then determines the quality of user responses, for example whether the returned responses are correct. In accordance with a determination that the user has correctly responded to the question, the evaluation system 144 saves the correct answer in a database of user information. In accordance with a determination that the user did not answer the question correctly, the evaluation system 144 analyzes the response to determine what errors the user made (e.g., a typo, a grammatical mistake, selection of the second best answer in a multiple choice, a calculation error) and uses the error type to determine the user proficiency level. For example, a simple typo will result in the user getting most of the credit in a translation exercise, while multiple grammar and vocabulary mistakes will result in a low amount of credit.

In some example embodiments, the evaluation system 144 can evaluate answers such that the user gain points for correct answers but lose points or has points discounted based on incorrect answers. For example, for the prompt “Which of these are real English words?”, the user receives positive points based on the real English words selected, but the evaluation system also factors in the probability that the user was guessing based on the number of fake English words incorrectly marked as real.

The evaluation system 144 then maintains an updatable estimate of the proficiency of the user. Each question that the user responds to results in further updates to the estimate of the user's score.

As results are received from client system 102 associated with a user and the estimated proficiency score for the user is updated, the selection system 142 selects the next question to be delivered to the client system 102 for presentation to the user. The selection system 142 uses the updated proficiency score to select the next question to deliver to the user.

Once the entire evaluation is complete (e.g., a certain number of questions have been sent or a certain level of certainty about the user's proficiency has been reached), the prompt system 150 selects an open-ended interview prompt from a plurality of possible open-ended interview prompts. This selection is made based on the user's determined level of proficiency. The prompt system 150 then transmits the open-ended interview prompt to the client system 102 with instructions to ensure that the third-party application 132 causes the client system 102 to record a live video of the user responding to the prompt in a specific amount of time. For example the user is given 60 seconds to answer the question “What is your favorite animal and why?”

In some example embodiments, the prompt system 150 receives the recorded live video of the user's response to the selected prompt and stores it with other user profile data for use later. Third parties can then, with the user's permission, request both the user proficiency score and the one or more recorded live videos of the user's response to interview prompts.

Further, while the client-server-based network architecture 100 shown in FIG. 1 employs client-server architecture, embodiments are not limited to such an architecture, and could equally well find application in a distributed, or peer-to-peer, architecture system, for example. The various systems including the selection system 142, the evaluation system(s) 144, and the prompt system 150 could also be implemented as standalone software programs, which do not necessarily have networking capabilities.

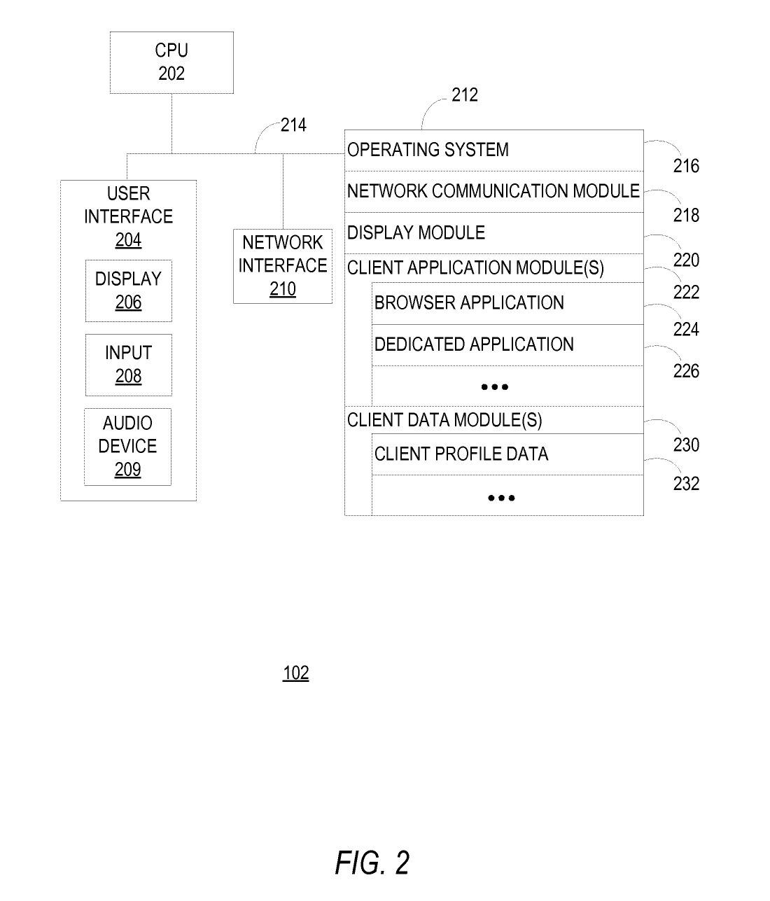

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input device 208 such as a keyboard, mouse, touch sensitive display, or other input means. Furthermore, some client systems 102 use a microphone and voice recognition, such as an audio device 209, to supplement or replace other input devices.

The memory 212 includes high-speed random access memory, such as dynamic random-access memory (DRAM), static random access memory (SRAM), double data rate random access memory (DDR RAM) or other random access solid state memory devices, and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more network interfaces 210 (wired or wireless) and one or more communication networks 104, such as the Internet, other WANs, LANs, MANs, etc.;
a display module 220 for enabling the information generated by the operating system 216 and the client application(s) 114 to be presented visually on the display device 206;
one or more client application modules 222 for handling various aspects of interacting with the server system 120 (FIG. 1), including but not limited to:
   a browser application 224 for requesting information from the server system 120 (e.g., interactive excises) and receiving responses from the server system 120 especially when no dedicated application is installed on the client system 102 for communicating with the server system 120; and
   a dedicated application 226 associated with the server system 120 and specifically configured to send, receive, and display data from the server system 120 including evaluation questions, prompts, and user recordings, and so on; and
client data module(s) 230 for storing data relevant to the clients, including but not limited to:
   client profile data 232 for storing profile data related to a user (e.g., user 106) of the server system 120 associated with the client system 102.

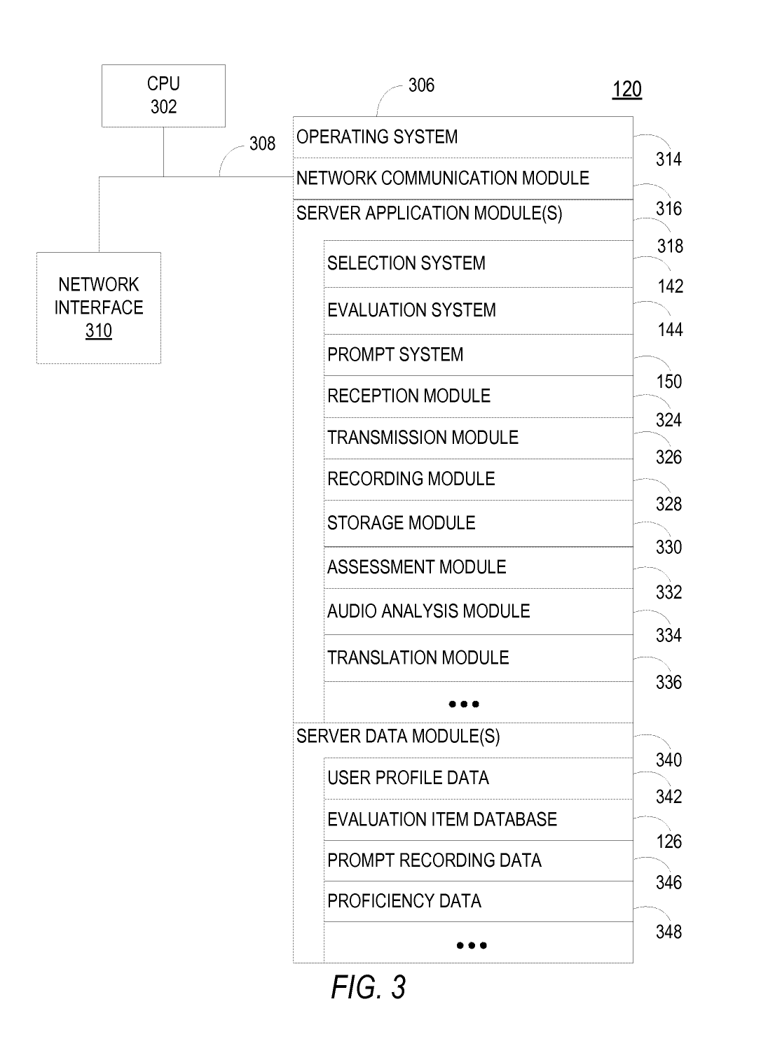

FIG. 3 is a block diagram further illustrating the server system 120, in accordance with some example embodiments. The server system 120 typically includes one or more CPUs 302, one or more network interfaces 310, memory 306, and one or more communication buses 308 for interconnecting these components. The memory 306 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternately the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the server system 120 to other computers via the one or more network interfaces 310 (wired or wireless) and one or more communication networks 104, such as the Internet, other WANs, LANs, MANs, and so on;
one or more server application modules 318 for performing the services offered by the server system 120, including but not limited to:
   a selection system 142 for, when a user requests an evaluation, selecting one or more evaluation questions based on the type of evaluation requested, metadata about each potential question, and information about the user's history and proficiency with the evaluated skills;
   an evaluation system 144 for receiving user feedback and comparing it against one or more stored predetermined acceptable responses to determine the user's proficiency with the particular skill;
   a prompt system 150 for selecting, based on the determined user proficiency level, an open-ended interview prompt to which the user is requested to respond (e.g., an interview question, a difficult challenge related to a particular skill, and so on);
   a reception module 324 for receiving requests from client systems (e.g., the client system 102 in FIG. 1), requests from third-party systems (e.g., the third-party server 130 in FIG. 1), and user responses to evaluation exercises;
   a transmission module 326 for transmitting one or more selected evaluation prompts and open-ended interview prompts to a client system (e.g., the client system 102 in FIG. 1);
   a recording module 328 for instructing a client system (e.g., the client system 102 in FIG. 1) to record a user giving an open-ended response to a prompt, question, or challenge;
   a storage module 330 for storing data in the server data module 340 including user profile data 342, evaluation item database 126, user proficiency data 348, and prompt recording data 346;
   an assessment module 332 for assessing a user's proficiency for a given skill or area of knowledge based on the user's response to a plurality of evaluation questions;
   an audio analysis module 334 for analyzing received user audio to extract text representing the user response data to a particular exercise; and
   a translation module 336 for converting sponsored messages into languages different than the original language; and
server data module(s) 340, storing data related to the server system 120, including but not limited to:
   user profile data 342, including both data provided by the user, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred user information based on user activity, social graph data, past history with interactive user applications, language proficiency, and so on;
   evaluation item database 126 including all potential evaluation questions and prompts used to assess a user's competency with a specific skill;
   prompt recording data 346 including recorded and/or storing data received from a client system (e.g., the client system 102 in FIG. 1) that includes a user responding to an open-ended interview style question; and
   proficiency data 348 for storing data about a user's proficiency with one or more specific skills.

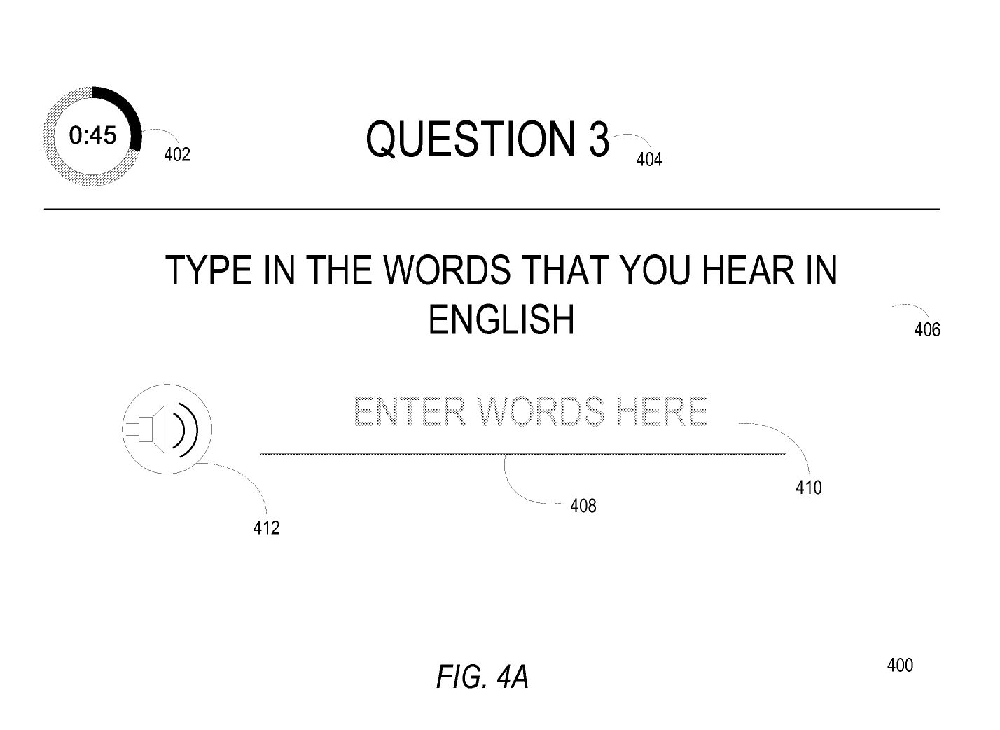

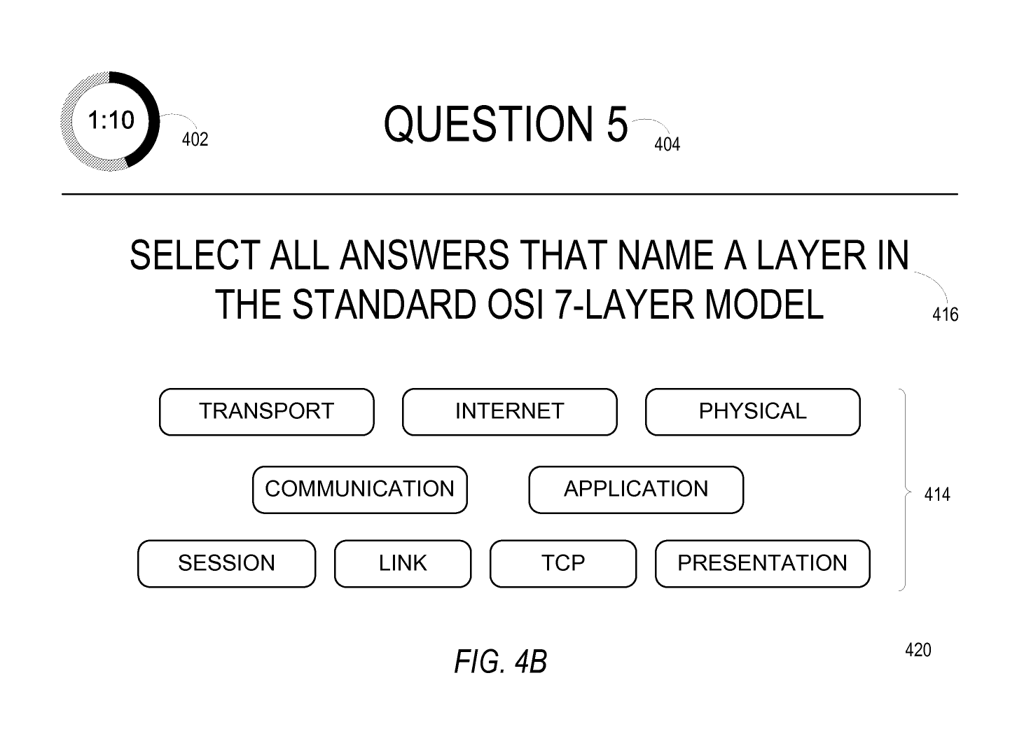

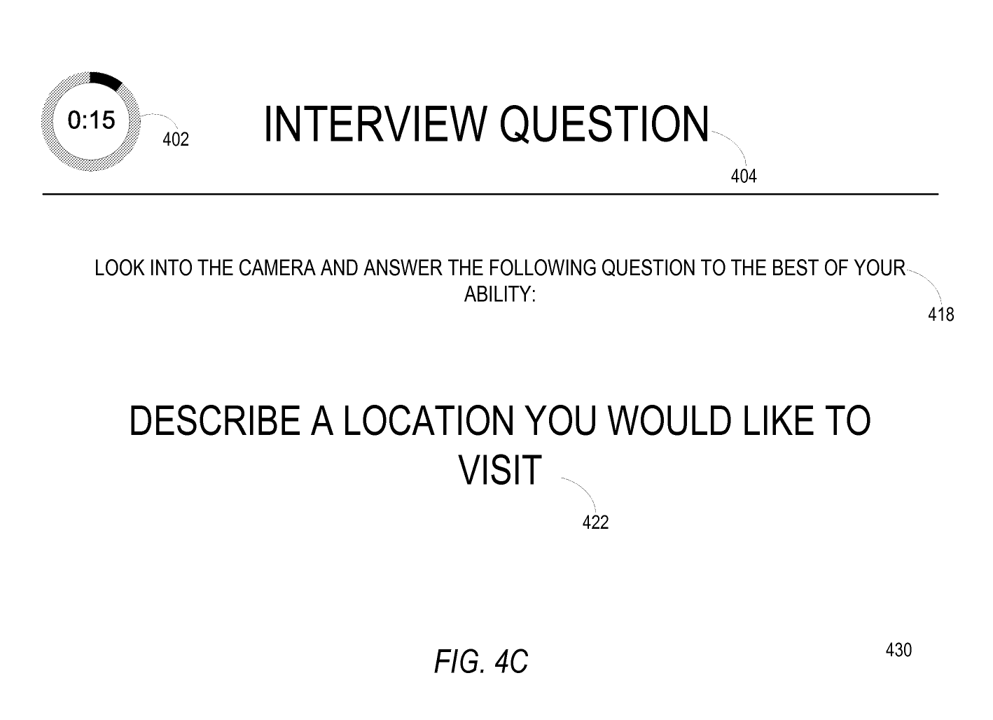

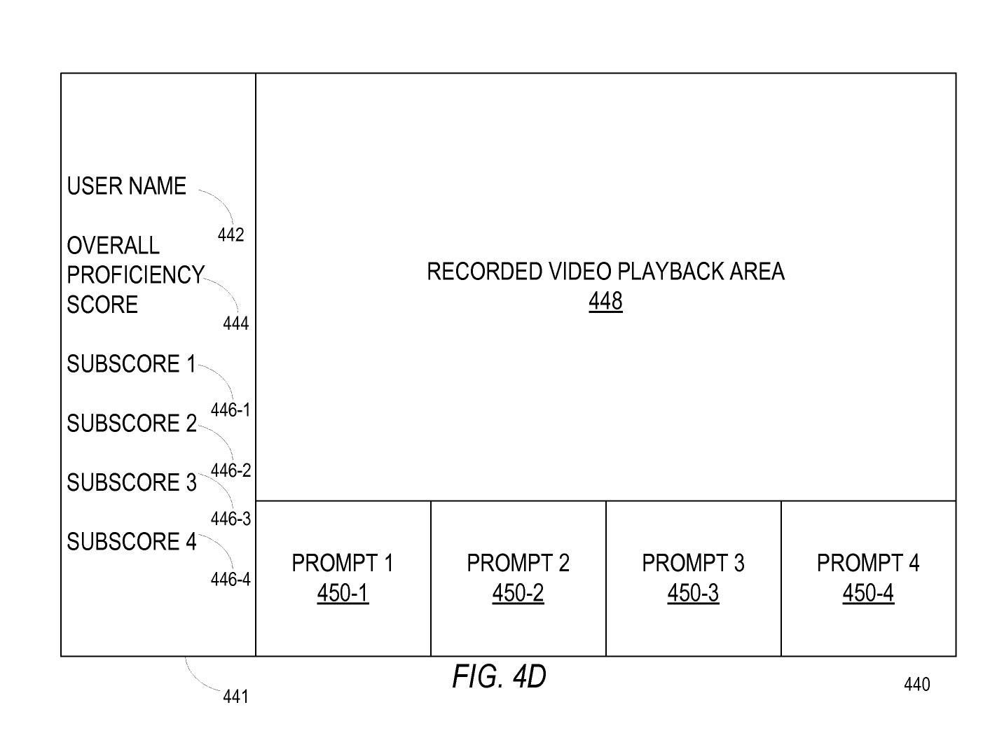

FIG. 4A illustrates an exemplary user interface 400 for an example evaluation application associated with a server system (e.g., the server system 120 in FIG. 1). In this example the user interface 400 is displayed on a screen (e.g., the screen of a personal computer, tablet computer, smartphone, or other electronic device). The user interface 400 for the evaluation application includes a timer 402 representing the amount of time left for the user to respond to the displayed question or prompt 406. The user interface 400 includes a title area 404 identifying the question (e.g., which question in the sequence of questions is currently being displayed.)

In this example, the user interface 400 also includes a prompt 406. The prompt 406 shown includes the words “Type the words you hear in English” to clearly inform the user that the user will hear one or more words and will need to translate them from a first language into English and then type the translated English sentence into the text input area 408. The text input area 408 is the section of the user interface 400 in which the user will enter the translated text. In some example embodiments, the user can select the displayed sound icon 412 to cause the audio recording of the original words or phrase to be played again.

In this example, the user interface 400 also includes a text input area 410 in which a user can enter words in response to a prompt 408.

FIG. 4B illustrates another example of a user interface 420 for an interactive language learning application associated with a server system (e.g., the server system 120 in FIG. 1).

In this example, the user interface 420 is displayed on a screen (e.g., the screen of a personal computer, tablet computer, smartphone, or other electronic device). The user interface 420 for the evaluation application includes a timer 402 representing the amount of time left for the user to respond to the displayed question or prompt 416. The user interface 420 includes a title area 404 identifying the question (e.g., which question in the sequence of questions is currently being displayed.)

In this example, the user interface 420 includes a question or prompt 416. This example exercise also includes a series of options 414 that the user can select. The user responds to the prompt by selecting one or more of the displayed options 414.

FIG. 4C illustrates another exemplary user interface 430 for an interactive language learning application associated with a server system (e.g., the server system 120 in FIG. 1).

In this example, the user interface 430 is displayed on a screen (e.g., the screen of a personal computer, tablet computer, smartphone, or other electronic device). The user interface 430 for the evaluation application includes a timer 402 representing the amount of time left for the user to respond to the displayed question or prompt 422. The user interface 430 includes a title area 404 identifying the question (e.g., which question in the sequence of questions is currently being displayed.)

In this example, the user interface 430 includes a question or prompt 422. This example exercise also includes instructions 418 to the user about how to respond to the prompt. Thus, the user is instructed to look directly into the camera associated with the client system (e.g., the client system 102 in FIG. 1) and answer the prompt 422 verbally. The server system (e.g., the server system 120 in FIG. 1) also instructs the client system (e.g., the client system 102 in FIG. 1) to record the answer with an attached or associated camera or other video recording device.

FIG. 4D illustrates another exemplary user interface 440 for allowing a third party to review the results of a proficiency evaluation for a user by a server system (e.g., the server system 120 in FIG. 1).

In this example, the user interface 440 presents user information in a results pane 441. User information includes the user name 442 (e.g., the name of the user associated with this user profile). The results pane 441 also includes an overall proficiency score 444 and one or more sub-scores (446-1 to 446-4). In some example embodiments, the overall proficiency score 444 is represented as an integer value that is an estimate of the user's current proficiency level based on the one or more sub-scores (446-1 to 446-4). Each sub-score represents a component skill of the overall proficiency. For example, learning a language component skills may include reading, pronunciation, vocabulary, and grammar proficiency. In other example embodiments, the sub-scores are reading, writing, listening, and speaking Each sub-score can include a composition and a comprehension component.

The user interface 440 also includes a recorded video playback area 448 that is used to display a recorded video of the user responding to a prompt. In this way the third party can evaluate the user's proficiency based on a live video in a way that simulates an interview.

The user interface 440 also includes a video selection area. The video selection area includes a plurality of prompts (450-1 to 450-4), each of which represents a video of the user responding to that prompt. The third party can then select a prompt 450 and the corresponding video will be presented in the recorded video playback area 448.

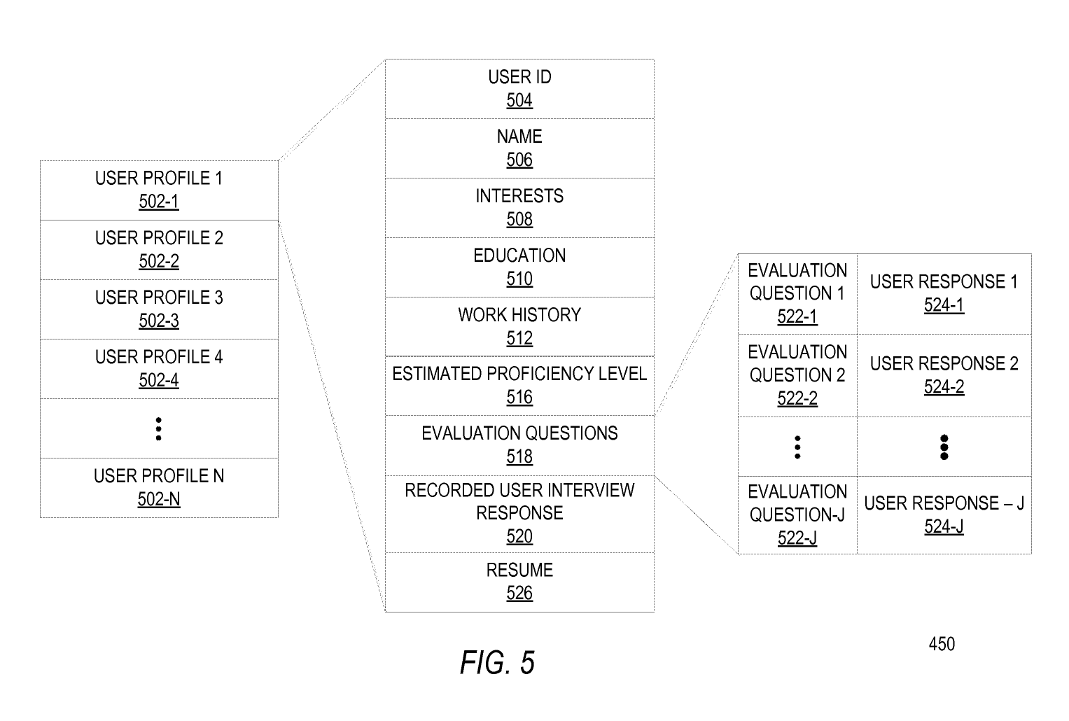

FIG. 5 depicts a block diagram of an exemplary data structure for the user profile data 500 for storing user profiles in accordance with some example embodiments. In some example embodiments, the user profile data 500 includes a plurality of user profiles 502-1 to 502-N, each of which corresponds to a user of the server system (e.g., the server system 120 in FIG. 1).

In some implementations, a respective user profile 502 stores a unique user ID 504 for the user profile 502, the name 506 of the user (e.g., the member's legal name), user interests 508, user education history 510 (e.g., the universities or trade schools the member attended and the subjects studied), user employment history 512 (e.g., user's past and present work history with job titles), the user's estimated proficiency level 516, evaluation questions 518, a recorded user interview response 520 (e.g., a video file from a client system (e.g., the client system 102 in FIG. 1) that records a user responding to a prompt), and a resume 526.

In some example embodiments, the server system (e.g., the server system 120 in FIG. 1) uses a series of questions (e.g., the questions listed in evaluation questions 518) to estimate the user's proficiency for a given skill and based on the answers, and generates a proficiency score that is then stored in the user's estimated proficiency level 516. In some example embodiments, the estimated proficiency level 516 is represented as an integer. In other example embodiments, the proficiency level includes a plurality of different factors (e.g., different facets of a skill) and gives users a sub-score in each factor. For example, when estimating a user's proficiency with a language, the estimated proficiency level 516 may include separate sub-scores for grammar, vocabulary, reading comprehension, and understanding spoken language.

In some example embodiments, a user profile 502 will include estimated proficiency levels 516 for a plurality of skills. For example, a user uses the server system (e.g., the server system 120 in FIG. 1) to evaluate their proficiency in computer programming in Python and later uses the server system (e.g., the server system 120 in FIG. 1) to evaluate their culinary skills. The server system (e.g., the server system 120 in FIG. 1) can store an estimated proficiency level 516 for each skill in the same user profile 502.

A user profile 502 includes a list of evaluation questions (522-1 to 522-J) and associated user responses (524-1 to 524-J). Each entry for an evaluation question 522 lists the type of evaluation question (e.g., multiple choice, true-false, fill in the blank, short answer, and so on.).

Each user response 524 is a record of the response the user sent to the respective evaluation question 522. For example, if the question was a multiple choice question, the user response 524 record will include the specific multiple choice question that the user selected. In another example the user response 524 includes an audio recording of a verbal answer given by the user in response to a prompt. In some example embodiments, the evaluation questions 522 and their accompanying user responses 524 can be shared as part of an overall user profile such that a third party (e.g., potential employer or school) can more fully evaluate a user's qualifications or proficiency level. However, this additional data will only be available with the user's permission.

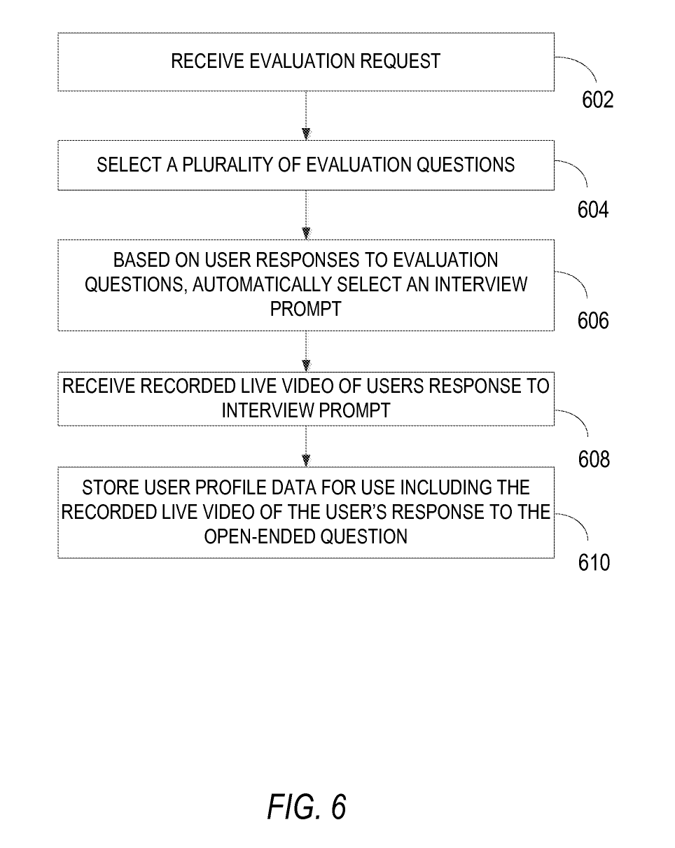

FIG. 6 is a flow diagram illustrating a method, in accordance with some example embodiments, for improving personalization and usability of evaluation services. Each of the operations shown in FIG. 6 may correspond to instructions stored in a computer memory or computer-readable storage medium. In some embodiments, the method described in FIG. 6 is performed by the server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

A server system (e.g., the server system 120 in FIG. 1) hosts an evaluation application and allows client systems (e.g., the client system 102 in FIG. 1) to remotely access the evaluation service. Thus, when a user wishes to use the evaluation service, the user accesses a client system (e.g., the client system 102 in FIG. 1) and sends a request to the server system (e.g., the server system 120 in FIG. 1) to begin an evaluation.

The server system (e.g., the server system 120 in FIG. 1) receives (602) the evaluation request. An evaluation request is a request from a user associated with a client system (e.g., the client system 102 in FIG. 1). The evaluation request includes an indication of the type of evaluation that the user requests. For example, the evaluation service offers testing over a variety of tests to evaluate different types of skills. The evaluation service can evaluate a user's proficiency with a language, test the user on a variety of academic subjects, perform accreditation, and so on. In some example embodiments, the evaluation request also includes information about the user, the user's history, demographic information, qualifications, past evaluations, and so on. In some example embodiments, this information is stored in user profiles stored at a database associated with the server system (e.g., the server system 120 in FIG. 1).

In response to receiving the evaluation request, the server system (e.g., the server system 120 in FIG. 1) selects (604) a plurality of evaluation questions. In some example embodiments, the evaluation questions are based on user information stored in the user profile (e.g., user's past education or qualifications). In some example embodiments, the set of questions are fixed (e.g., all users will get the same set of questions). In other example embodiments, the set of questions are customized based on user information.

In some example embodiments, each response from the user is used to update a running estimated user proficiency score. Once the estimated proficiency score has been updated, the server system (e.g., the server system 120 in FIG. 1) automatically selects a next question from a plurality of potential questions. In this way every user has a personalized evaluation session designed to more accurately determine the user's proficiency.

Once the server system (e.g., the server system 120 in FIG. 1) has transmitted all the selected questions to the client system (e.g., the client system 102 in FIG. 1) and received a response from the user, the server system (e.g., the server system 120 in FIG. 1) automatically selects (606) (in real-time) an open-ended interview prompt. For example, if the evaluation was about networked systems, the opened-ended question may be, “If you were in control of an entire computer network and were seeking to optimize the speed of a peer-to-peer file sharing network, what layer of the system would you focus on and why?” In another example, the evaluation is for language proficiency and the question is, “Where would you like to take a vacation?”

In some example embodiments, once the open-ended interview prompt is selected, the server system (e.g., the server system 120 in FIG. 1) transmits the selected prompt to the client system (e.g., the client system 102 in FIG. 1) for presentation to the user along with instructions to record the user's response with a camera (e.g. video camera, webcam, smart phone camera, and so on).

In some example embodiments, the server system (e.g., the server system 120 in FIG. 1) also transmits instructions or software that ensures that the user cannot cheat while answering the question.

In some example embodiments, the server system (e.g., the server system 120 in FIG. 1) monitors the users as they participate in the evaluation. For example, an evaluation application associated with the server system (e.g., the server system 120 in FIG. 1) runs on the client system (e.g., the client system 102 in FIG. 1) of the user during the evaluation and transmits both video of the user while the user is taking the evaluation and the contents of the display of the client system (e.g., the client system 102 in FIG. 1) during the evaluation.

In some example embodiments, the server system (e.g., the server system 120 in FIG. 1) can then monitor the received information to ensure that the user is not cheating during the evaluation. For example, the server system (e.g., the server system 120 in FIG. 1) can ensure that the user is not viewing resources off screen based on the position and movement of the users head or eyes. In addition, the server system (e.g., the server system 120 in FIG. 1) can monitor the contents of the display of the client system (e.g., the client system 102 in FIG. 1) to ensure the user has not used a non-approved application to aid in the evaluation. In some example embodiments, the monitoring is done automatically by analyzing the incoming data. In other example embodiments, the monitoring is done by a live person associated with the server system (e.g., the server system 120 in FIG. 1) such as a proctor. In some example embodiments, the monitoring can be performed in real-time (e.g., as the test is being taken) or time-delayed (e.g., after the text has been completed.)

The server system (e.g., the server system 120 in FIG. 1) receives (608) the recorded live video (e.g., video that was recorded live) of the user's response to the selected open-ended interview prompt. Once the recorded live video has been received, the server system (e.g., the server system 120 in FIG. 1) stores it, along with all user information, in a user profile at the server system (e.g., the server system 120 in FIG. 1).

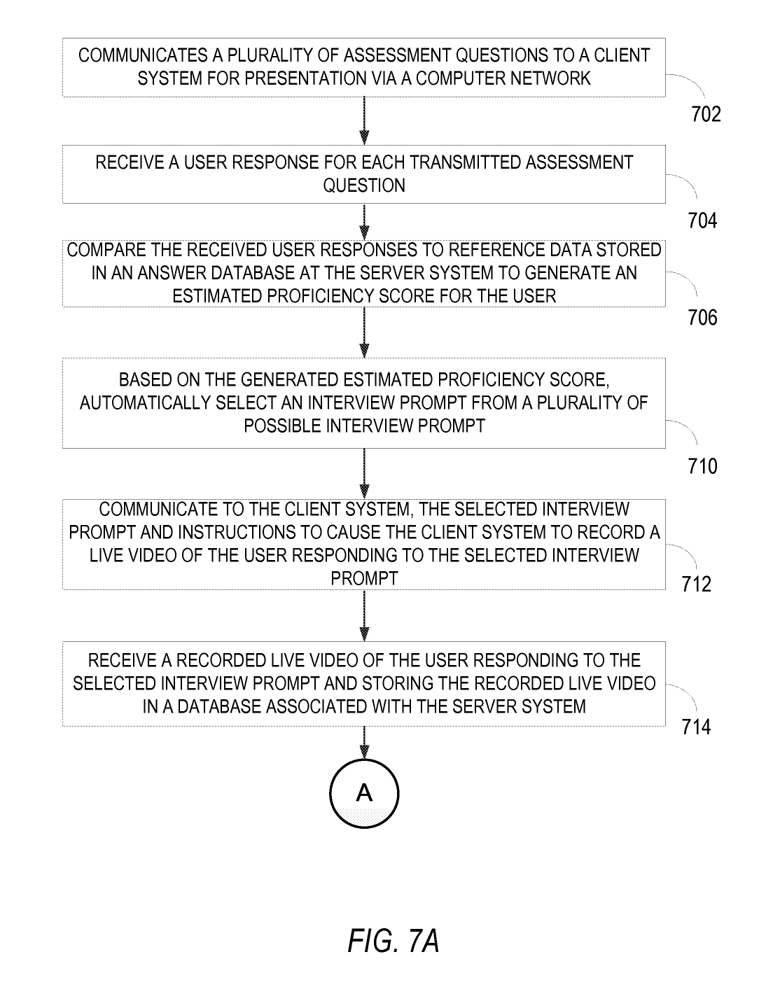

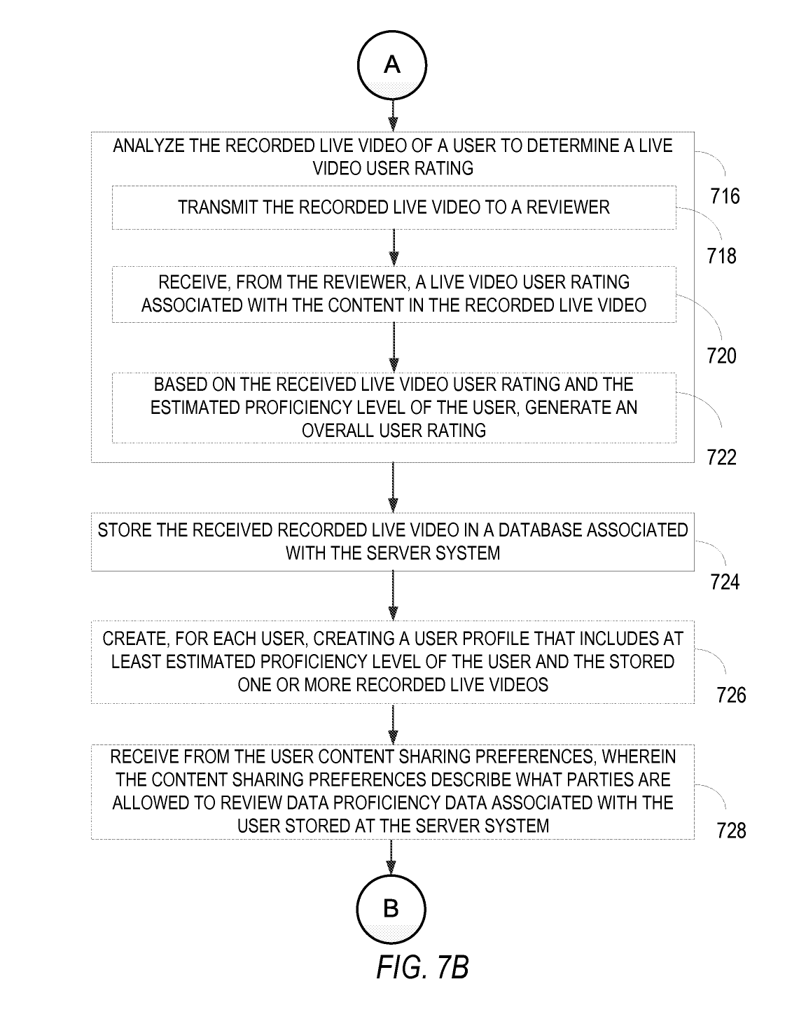

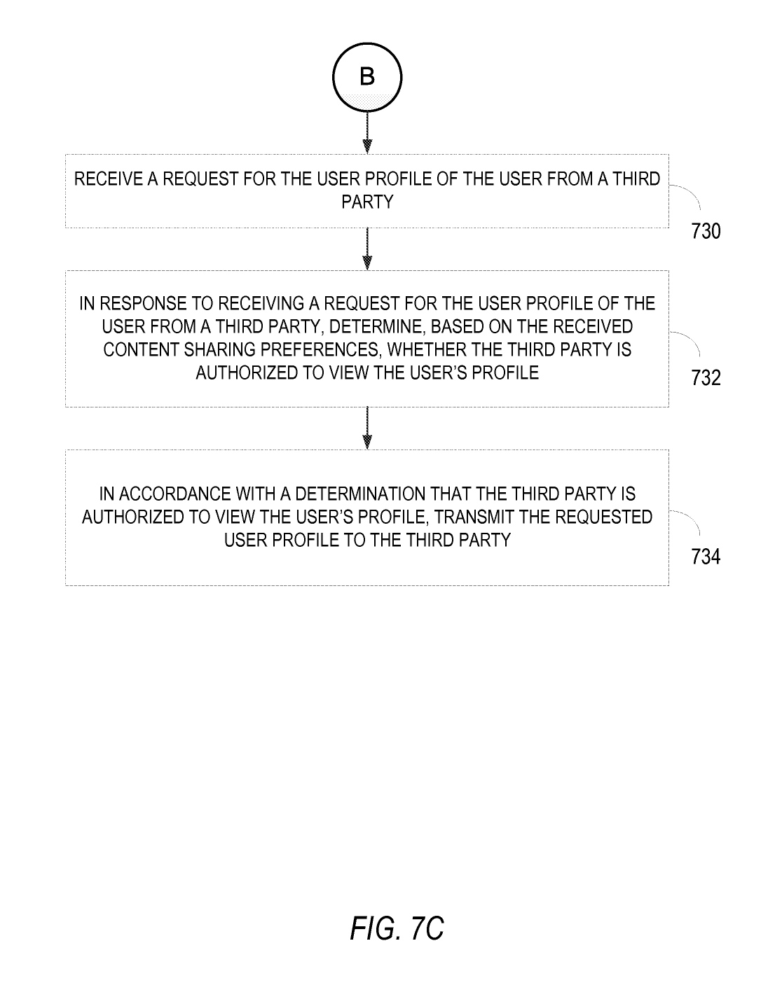

FIG. 7A is a flow diagram illustrating a method, in accordance with some example embodiments, for automatically selecting personalized interview questions. Each of the operations shown in FIG. 7A may correspond to instructions stored in a computer memory or computer-readable storage medium. Optional operations are indicated by dashed lines (e.g., boxes with dashed-line borders). In some embodiments, the method described in FIG. 7A is performed by a server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

A server system (e.g., the server system 120 in FIG. 1) hosts an evaluation platform or application. The server system (e.g., the server system 120 in FIG. 1) can include the ability to evaluate any skill or ability through a series of questions, prompts, and activities. When a user wants to be evaluated, the user can cause a client system (e.g., the client system 102 in FIG. 1) associated with the user to send an evaluation request to the server system (e.g., the server system 120 in FIG. 1).

In some example embodiments, an evaluation request includes at least the subject or skill for which the evaluation is requested. For example, the evaluation application measures language skills, cognitive abilities, knowledge of various subjects such as mathematics, physics, history, or geography, professional skills such as accounting, programming, law, medical or dentistry, and so on.

In response to receiving an evaluation request from a client system (e.g., the client system 102 in FIG. 1), the server system (e.g., the server system 120 in FIG. 1) communicates (702) over a computer network, a plurality of assessment questions to a client system for presentation to a user through a user interface displayed at the client system. In some example embodiments, the server system (e.g., the server system 120 in FIG. 1) transmits a fixed number of questions for each potential topic or area (e.g., the questions are predetermined). In other example embodiments, the server system (e.g., the server system 120 in FIG. 1) transmits one of a plurality of questions sets (e.g., each set is predefined) based on information received with the evaluation request (e.g., background of the user, purpose of the evaluation, and so on).

In some example embodiments, question or prompt types include, but are not limited to reading a sentence out loud, transcribing an audio recording into the same language or a distinct language, selecting items from a list that have a certain property (e.g., real words in a target language from a pool that includes both real and invented words), multiple-choice questions, selecting an appropriate response to fill in a missing word in a paragraph or sentence from a drop down menu, matching or connecting items from two or more columns, ordering a set of items chronologically or by some other sequential criterion, and so on. In some example embodiments, the server system (e.g., the server system 120 in FIG. 1) stores many thousands of potential questions for each evaluation topic, skill, or area.

In yet other example embodiments, the server system (e.g., the server system 120 in FIG. 1) analyzes each answer of the user to determine an updated estimate of user proficiency and then selects the next question based on the information gained by analyzing the user response (e.g., information about what the user knows or what skills the user has). For example, a user who is done well previous questions will likely receive more difficult further questions than a user who has done poorly on previous questions. In some example embodiments, each question is associated with one or more of the sub-areas of a particular skill or field of knowledge (e.g., are used to generate each different sub-score).

The server system (e.g., the server system 120 in FIG. 1) receives (704) a user response for each transmitted assessment question, wherein each user response is entered by the user by interacting with a user interface displayed at the client system. A user response can be transmitted as a text response, a selection of an option, an audio response, or a video response.

The server system (e.g., the server system 120 in FIG. 1) compares (706) the received user responses to reference data stored in an answer database at the server system to generate an estimated proficiency score for the user. For example, the server system (e.g., the server system 120 in FIG. 1) determines if the user selected the correct option in a multiple choice question. In other example embodiments, the server system (e.g., the server system 120 in FIG. 1) converts an audio response into text and then compares against a predetermined answer text.

The server system (e.g., the server system 120 in FIG. 1) generates an estimated proficiency score for the user based on user responses. In some example embodiments, the estimated proficiency level of the user is represented as an integer score. For example, the estimated proficiency level for language proficiency is rated as an integer between 1 and 10. In other example embodiments, estimated proficiency level is represented by grouping users into one of a plurality of categories such as “No proficiency”, “Novice”, “Intermediate”, “Competent”, and “Expert.” In some example embodiments, both are used.

In some example embodiments, the estimated proficiency level of the user is a composite score composed of a plurality of sub-scores. Each sub-score in the plurality of sub-scores is associated with a particular aspect of the skill being evaluated. For example, a language assessment may report sub-scores for reading, writing, listening, and speaking skills. In some example embodiments, each assessment question is associated with a single sub-score and is thus used to compute that sub-score. In other example embodiments, each assessment question measures components of more than one sub-score, and the responses from the user are analyzed to determine how the user performed on each of the different sub-score areas.

Based on the generated estimated proficiency score, the server system (e.g., the server system 120 in FIG. 1) automatically selects (710) an interview prompt (e.g., an open-ended interview question or task) from a plurality of possible interview prompts. For example, if there are several hundred potential open-ended interview style questions, the server system (e.g., the server system 120 in FIG. 1) organizes them based on which proficiency level they would be appropriate for. Then, the server system (e.g., the server system 120 in FIG. 1) selects one or more of the interview style questions that match the estimated proficiency level of the user. In some example embodiments, the specific questions are selected randomly, or pseudo-randomly, such that users cannot predict which open-ended interview questions will be selected. For example, the following pseudo code may be used to select one or more of the interview style questions:

struct InterviewPrompt:

| | |
|---|---|
| id | // unique prompt identifier |
| prompt_type | // sub-skill, format, modality, etc. |
| score_range | // e.g., low/medium/high skill |
| prep_time | // time allowed for preparation |
| min_time | // minimum response time |
| max_time | // maximum response time |
| question_data | // prompt content |

function select_prompts(user_score, prompt_db):

// convert proficiency to category or range (e.g.,
low/medium/high)
score_range = normalize(user_score)
my_prompts = [ ]
// iterate over different sub-skills, formats, modalities, etc.
foreach prompt_type in prompt_db.types:
// randomly select prompt for the appropriate type and range

my_prompts.add(prompt_db.random(prompt_type,
score_range))

return my_prompts

For example, when conducting a language proficiency evaluation, and if the user has low ability in the language (e.g. a score of 1 out of 10), the server system (e.g., the server system 120 in FIG. 1) selects a basic descriptive question. For example: the selected interview question “What is your favorite kind of food?”

In another example, a user is determined to be at native or near-native fluency (e.g. a score of 9 out of 10), the server system (e.g., the server system 120 in FIG. 1) will select a much more challenging prompt that involves complicated shades of meaning and so on. For example, a selected question might be “Do you think high school students should be forced to do a year of community service? Explain your position.”

In some example embodiments, more than one open-ended interview style questions are selected so that the user will have several different questions to respond to. In some example embodiments, each selected open-ended interview question includes one of a text-based question prompt, an audio question prompt, and a video question prompt. In some example embodiments, each selected interview question is intended to showcase a different skill. For example, in a programming assessment, interview prompts may be focused on complexity analysis, data structures, or object-oriented programming.

In some example embodiments, the open-ended questions or prompts provided to the test taker are selected or generated from a large database of level-appropriate questions. In this way a user cannot memorize all possible questions prior to the evaluation. In some example embodiments, each interview style question includes both a fixed amount of time to think or prepare before responding (e.g., 50 seconds) and a minimum and maximum duration (e.g., 20-50 seconds). Thus, once the preparation time expires the client system (e.g., the client system 102 in FIG. 1) begins recording the user.

In some example embodiments, the open-ended interview prompt can be used by the server system (e.g., the server system 120 in FIG. 1) without any previous assessment questions. In this case, the one or more interview prompts are selected based on information submitted by the user, such as a self-disclosed proficiency score, an estimated score, a pre-existing fluency score, or a proficiency rating by an outside group (e.g., another assessment whose scores have been linked to the current assessment), or any other measurement that can be used to adaptively select interview prompts (e.g., if the server system 120 is able to understand the measure and relate it to the interview prompts.).

The server system (e.g., the server system 120 in FIG. 1) communicates (712), to the client system, the selected interview prompt and instructions to cause the client system to record a live video of the user responding to the selected interview prompt. The server system (e.g., the server system 120 in FIG. 1) then receives (714) a recorded live video of the user responding to the selected interview prompt and storing the recorded live video in a database associated with the server system. In some example embodiments, the server system (e.g., the server system 120 in FIG. 1) receives a plurality of answer videos, each responding to a different prompt. In some example embodiments, the recorded live video answer serves as a speaking sample.

In some example embodiments, the server system (e.g., the server system 120 in FIG. 1) also transmits a screen of instructions to the user letting the user know how the open-ended interview questions will be given and how the user should responds. In some example embodiments, the instructions also include a sample question that will not be recorded permanently.

In some example embodiments, the interview prompt requires the users to demonstrate a skill, rather than reply vocally. For example, an evaluation for a medical doctor could involve first answering questions to determine appropriate difficulty level and then being given the prompt to perform a specific simulated robotic surgery, which would be the open-ended portion of the evaluation. The video of which would be shared with potential hiring hospitals. Similarly, an evaluation for a computer software professional would involve debugging a computer program as the open-ended portion of the evaluation.

FIG. 7B is a flow diagram illustrating a method (continuing from FIG. 7A), in accordance with some example embodiments, for automatically selecting personalized interview question. Each of the operations shown in FIG. 7B may correspond to instructions stored in a computer memory or computer-readable storage medium. Optional operations are indicated by dashed lines (e.g., boxes with dashed-line borders). In some embodiments, the method described in FIG. 7B is performed by a server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

Once the recorded live video is received, the server system (e.g., the server system 120 in FIG. 1) analyzes (716) the recorded live video of a user to determine a live video user rating. In some example embodiments, analyzing the recorded live video further comprises the server system (e.g., the server system 120 in FIG. 1) transmitting (718) the recorded live video to a reviewer.

In some example embodiments, the recorded live video of a user is also analyzed (either by a reviewer or automatically) to verify the identity of the user and the validity of the test. In some example embodiments, the user's identity is determined by obtaining a picture of the user prior to the beginning of the evaluation, either from the user themselves or a third party source. This picture is then compared to the live video of the user during the evaluation to ensure that they match. In some example embodiments, this comparison is down automatically using facial analysis tools. In other example embodiments, a proctor (e.g., a live person) will compare the images from the evaluation to the picture of the user.

The server system (e.g., the server system 120 in FIG. 1) receives (720), from the reviewer, a live video user rating associated with the content in the recorded live video. For example, a dedicated computer module is assigned the process of reviewing video interview responses. In other example embodiments, the recorded live video responses are sent to a third-party system for review.

In some example embodiments, the live video user rating is reported on a scale of 0-10. However, the live video user rating and the estimated user proficiency score can be aligned with existing measures of user proficiency. For example, a proficiency score generated by the server system (e.g., the server system 120 in FIG. 1) is aligned with the common European framework of reference for languages (CEFR) score. In this way, the scores assigned by the server system (e.g., the server system 120 in FIG. 1) can be easily understood and evaluated by users more familiar with other standards or methods of measuring proficiency.

Based on the received live video user rating and the estimated proficiency level of the user, the server system (e.g., the server system 120 in FIG. 1) generates (722) an overall user rating. For example, the server system (e.g., the server system 120 in FIG. 1) averages all the sub-scores to arrive at a composite score. In other example embodiments, each sub-score is assigned a weight (based on the determined importance of each sub-score to overall skill proficiency level). Then the sub-scores are combined based on their assigned weight such that the sub-scores with greater weights have more impact on the final score. For example, if there were three sub-scores (A, B, and C) with three weights (0.5, 0.3, and 0.2), the composite score could be generated as follows:

Composite score=A*0.5+B*0.3+C*0.2.

When the server system (e.g., the server system 120 in FIG. 1) receives (714) the recorded live video, the video is stored (724) in a database associated with the server system. In this way, the recorded live video is available for use by the user being evaluated.

The server system (e.g., the server system 120 in FIG. 1) then creates (726), for each user, a user profile that includes at least estimated proficiency level of the user and the stored one or more recorded live videos. The user profile may also include demographic information about the user and any other information that may be used when evaluating a candidate for an opportunity (e.g., job interview, admission to a school, and so on).

The server system (e.g., the server system 120 in FIG. 1) receives (728), from the user, content sharing preferences, wherein the content sharing preferences describe what parties are allowed to review proficiency data associated with the user stored at the server system. For example, the user can transmit a list of email addresses for users that are allowed to request the qualification information. In other example embodiments, the information is posted publicly and the user transmits the public address of the information to parties that the user wishes to see the information. In yet other examples, the information is hidden behind a password and the user transmits the password to parties that the user permits to view the information.

In some example embodiments, the users can include or link the results of the evaluation (e.g., the user proficiency profile) as part of an online resume. In some example embodiments, the online resume is included as part of a user profile on a job-seeking or social networking site.

In some example embodiments, the evaluation is included as part of another service, such as a recruiting software. Thus, the recruiting service could include, as part of an interviewing workflow, one of the evaluations provided by the server system (e.g., the server system 120 in FIG. 1). Once the evaluation were completed, the results (the users proficiency score and interview videos) can be then included as part of the candidates online record on the recruiting service. Alternatively, a user can share/connect prior results to a company's recruiting platform.

FIG. 7C is a flow diagram illustrating a method (continuing from FIG. 7A and FIG. 7B), in accordance with some example embodiments, for automatically selecting personalized interview question. Each of the operations shown in FIG. 7C may correspond to instructions stored in a computer memory or computer-readable storage medium. Optional operations are indicated by dashed lines (e.g., boxes with dashed-line borders). In some embodiments, the method described in FIG. 7C is performed by a server system (e.g., the server system 120 in FIG. 1). However, the method described can also be performed by any other suitable configuration of electronic hardware.

In some embodiments the method is performed at a server system (e.g., the server system 120 in FIG. 1) including one or more processors and memory storing one or more programs for execution by the one or more processors.

The server system (e.g., the server system 120 in FIG. 1) receives a request (730) for the user profile of the user from a third party. For example, a user applies to a school and wants to demonstrate their proficiency with the language spoken at the school. The user can use the evaluation services of the server system (e.g., the server system 120 in FIG. 1) and then instruct the school (the third party in this case) to request the qualification information from the server system (e.g., the server system 120 in FIG. 1). The school then sends a request for qualification information to the server system (e.g., the server system 120 in FIG. 1).

In response to receiving a request for the user profile of the user from a third party, the server system (e.g., the server system 120 in FIG. 1) determines (732), based on the received content sharing preferences, whether the third party is authorized to view the user's profile. For example, the server system (e.g., the server system 120 in FIG. 1) compares the e-mail address, password, identification number, or other identifying information to determine whether the third party is authorized to access the user profile.

In accordance with a determination that the third party is authorized to view the user's qualification information, the server system (e.g., the server system 120 in FIG. 1) transmits (734) the requested user profile to the third party. In some example embodiments, the user profile information includes at least an estimated proficiency level of the user and a recorded live user answer from the user.

In some example embodiments, the server system (e.g., the server system 120 in FIG. 1) monitors the amount of time that the third party users spend watching each video. For example, an evaluator may be able to get an accurate picture of a user's language skills in just 10 seconds of video viewing. Thus, the server system (e.g., the server system 120 in FIG. 1) can use information about which videos are viewed and for how long to select the best or most useful open-ended interview questions, eliminate poor questions, and fine-tune the time that a user is given to respond to each question.

In some example embodiments, the third party users can also give feedback for each user profile that they view. For example, the third-party users can give an overall rating to each member. In other example embodiments, the third party users can rank a member on a series of categories. Once ranking data for a user has been collected from one or more third party users, the server system (e.g., the server system 120 in FIG. 1) can compare the third party rankings to the expected user rankings. The server system (e.g., the server system 120 in FIG. 1) can then use this data to evaluate the evaluation process. For example, if users who have a certain question are consistently rated higher by third-party than their estimated proficiency level, the server system (e.g., the server system 120 in FIG. 1) recalibrates the question to more be used more accurately in estimating user proficiency.

Thus, the server system (e.g., the server system 120 in FIG. 1) uses feedback from the third-party users to determine whether questions are being used appropriately. The server system (e.g., the server system 120 in FIG. 1) can then adjust the difficultly of questions, the length of questions, the format of questions, the answer duration, and so on to improve the quality of the evaluation. In some example embodiments, the server system (e.g., the server system 120 in FIG. 1) can use expert opinion to review evaluation questions and further improve the system.

### Software Architecture

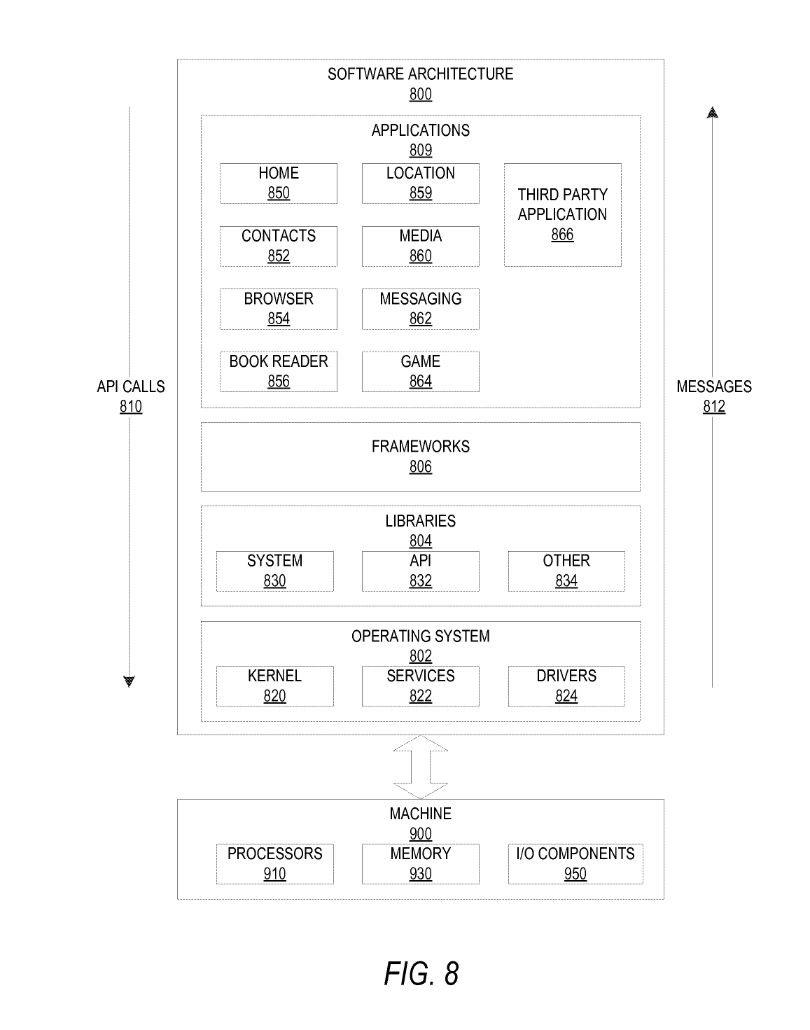

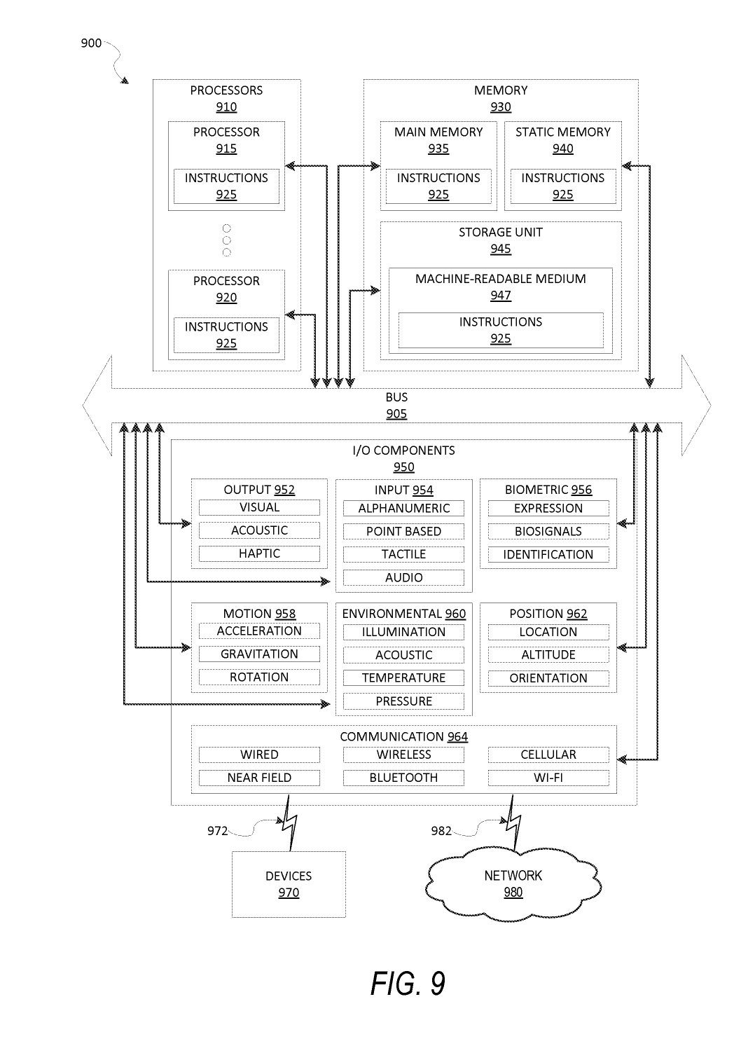

FIG. 8 is a block diagram illustrating an architecture of software 800, which may be installed on any one or more of the devices of FIG. 1. FIG. 8 is merely a non-limiting example of an architecture of software 800 and it will be appreciated that many other architectures may be implemented to facilitate the functionality described herein. The software 800 may be executing on hardware such as a machine 900 of FIG. 9 that includes processors 910, memory 930, and input/output (I/O) components 950. In the example architecture of FIG. 8, the software 800 may be conceptualized as a stack of layers where each layer may provide particular functionality. For example, the software 800 may include layers such as an operating system 802, libraries 804, frameworks 806, and applications 809. Operationally, the applications 809 may invoke API calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 809. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., a WebKit that may provide web browsing functionality), and the like. The libraries 804 may also include a wide variety of other libraries 834 to provide many other APIs to the applications 809.

The frameworks 806 may provide a high-level common infrastructure that may be utilized by the applications 809. For example, the frameworks 806 may provide various graphical user interface (GUI) functions, high-level resource management, high-level location services, and so forth. The frameworks 806 may provide a broad spectrum of other APIs that may be utilized by the applications 809, some of which may be specific to a particular operating system 802 or platform.

The applications 809 include a home application 850, a contacts application 852, a browser application 854, a book reader application 856, a location application 859, a media application 860, a messaging application 862, a game application 864, and a broad assortment of other applications such as a third party application 866. In a specific example, the third party application 866 (e.g., an application developed using the Android™ or iOS™ software development kit (SDK) by an entity other than the vendor of the particular platform) may be mobile software running on a mobile operating system 802 such as iOS™, Android™, Windows® Phone, or other mobile operating systems 802. In this example, the third party application 866 may invoke the API calls 810 provided by the operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system within which instructions 925 (e.g., software 800, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 915 and a processor 920, which may execute the instructions 925. The term “processor” is intended to include multi-core processors 910 that may comprise two or more independent processors 915, 920 (also referred to as “cores”) that may execute the instructions 925 contemporaneously. Although FIG. 9 shows multiple processors 910, the machine 900 may include a single processor 910 with a single core, a single processor 910 with multiple cores (e.g., a multi-core processor), multiple processors 910 with a single core, multiple processors 910 with multiple cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, the static memory 940, and the processors 910 may be considered machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown, in an example embodiment, to be a single medium, the term “machine-readable medium” should be taken to include a single medium or multiple media (e.g., a centralized or distributed database, or associated caches and servers) able to store the instructions 925. The term “machine-readable medium” shall also be taken to include any medium, or combination of multiple media, that is capable of storing instructions (e.g., instructions 925) for execution by a machine (e.g., machine 900), such that the instructions 925, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e g, infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be other machines 900 and/or any of a wide variety of peripheral devices (e.g., a peripheral device coupled via a USB).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 964 such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HTTP). Similarly, the instructions 925 may be transmitted and/or received using a transmission medium via the coupling 972 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software 800.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

What is claimed is:

1. A method comprising:
communicating, over a computer network, a plurality of assessment questions to a client system for presentation to a user through a user interface displayed at the client system;
receiving, at a server system, a user response for each transmitted assessment question, wherein each user response is received via a user interface displayed at the client system and configured for user input;
comparing the received user responses to reference data stored in an answer database at the server system to generate an estimated proficiency score for the user;
based on the generated estimated proficiency score, automatically selecting an interview prompt from a plurality of possible interview prompts;
communicating, to the client system, the selected interview prompt and instructions to cause the client system to record a live video of the user responding to the selected interview prompt; and
receiving a recorded live video of the user responding to the selected interview prompt and storing the recorded live video in a database associated with the server system.

2. The method of claim 1, further comprising, for each user, creating a user profile that includes at least an estimated proficiency level of the user and one or more stored recorded live videos.

3. The method of claim 2, further comprising:
receiving a request for the user profile of the user from a third party system; and
in response to receiving the request for the user profile of the user from the third party system, transmitting the requested user profile for the user to the third party system including at least the estimated proficiency level of the user and one or more stored recorded live videos.

4. The method of claim 3, further comprising:
receiving content sharing preferences from the user, wherein the content sharing preferences describe what parties are allowed to review proficiency data associated with the user stored at the server system;
in response to receiving the request for the user profile of the user from the third party, determining, based on the received content sharing preferences, whether the third party is authorized to view the user's profile; and
in accordance with a determination that the third party is authorized to view the user's profile, transmitting the requested user profile to the third party.

5. The method of claim 3, further comprising:
receiving prompt feedback from the third-party system; and
based on the received prompt feedback, adjusting a preparation time, a maximum response length, or a minimum response time length associated with an interview prompt.

6. The method of claim 1, wherein the selected interview prompt includes one of a text-based question prompt, an audio question prompt, and a video question prompt.

7. The method of claim 1, wherein the recorded live video of the user responding to the selected interview prompt serves as a speaking sample.

8. The method of claim 2, wherein the estimated proficiency level of the user is represented as an integer score.

9. The method of claim 2, wherein the estimated proficiency level of the user is a composite score composed of a plurality of sub-scores.

10. The method of claim 2, further comprising:
analyzing the recorded live video of the user responding to the selected interview prompt of the user to determine a live video user rating; and
based on the live video user rating and the estimated proficiency level of the user, generating an overall user rating.

11. The method of claim 10, wherein analyzing the recorded live answer video further comprises:
transmitting the recorded live answer video to a reviewer;
receiving, from the reviewer, a live video user rating associated with the content in the recorded live video.

12. The method of claim 1, wherein one or more of the plurality of assessment questions are selected, at least in part, based on user performance in answering assessment questions.

13. An electronic device comprising:
a communication module, using at least one processor of a machine, to communicate, over a computer network, a plurality of assessment questions to a client system for presentation to a user through a user interface displayed at the client system;
a reception module, using at least one processor of a machine, to receive a user response for each transmitted assessment question, wherein each user response is received via a user interface displayed at the client system and configured for user input;
a comparison module, using at least one processor of a machine, to compare the received user responses to reference data stored in an answer database at the server system to generate an estimated proficiency score for the user;
a selection module, using at least one processor of a machine, to, based on the generated estimated proficiency score, automatically selecting an interview prompt from a plurality of possible interview prompts;
an interviewing module, using at least one processor of a machine, to communicate, to the client system, the selected interview prompt and instructions to cause the client system to record a live video of the user responding to the selected interview prompt; and
an answer reception module, using at least one processor of a machine, to receive a recorded live video of the user responding to the selected interview prompt and storing the recorded live video in a database associated with the server system.

14. The electronic device of claim 13, further comprising, a creation module, using at least one processor of a machine, to, for each user, create a user profile that includes at least an estimated proficiency level of the user and one or more stored recorded live videos.

15. The electronic device of claim 14, further comprising:
a reception request module, using at least one processor of a machine, to receive a request for the user profile of the user from a third party system; and
a profile transmission module, using at least one processor of a machine, to, in response to receiving the request for the user profile of the user from the third party system, transmit the requested user profile for the user to the third party system including at least the estimated proficiency level of the user and one or more stored recorded live videos.

16. The device of claim 13, wherein the recorded live video of the user responding to the selected interview prompt serves as a speaking sample.

17. A non-transitory computer-readable storage medium storing instructions that, when executed by one or more processors of a machine, cause the machine to perform operations comprising:
communicating, over a computer network, a plurality of assessment questions to a client system for presentation to a user through a user interface displayed at the client system;
receiving, at a server system, a user response for each transmitted assessment question, wherein each user response is received via a user interface displayed at the client system and configured for user input;
comparing the received user responses to reference data stored in an answer database at the server system to generate an estimated proficiency score for the user;
based on the generated estimated proficiency score, automatically selecting an interview prompt from a plurality of possible interview prompts;
communicating, to the client system, the selected interview prompt and instructions to cause the client system to record a live video of the user responding to the selected interview prompt; and
receiving a recorded live video of the user responding to the selected interview prompt and storing the recorded live video in a database associated with the server system.

18. The non-transitory computer-readable storage medium of claim 17, further comprising instructions for, for each user, creating a user profile that includes at least an estimated proficiency level of the user and one or more stored recorded live videos.

19. The non-transitory computer-readable storage medium of claim 18, further comprising instructions for:
receiving a request for the user profile of the user from a third party system; and
in response to receiving the request for the user profile of the user from the third party system, transmitting the requested user profile for the user to the third party system including at least the estimated proficiency level of the user and one or more stored recorded live videos.

20. The non-transitory computer-readable storage medium of claim 18, wherein the estimated proficiency level of the user is represented as an integer score.
